(19) United States
(12) Patent Application Publication
(10) Pub. No.: US 2006/0080331 A1
(43) Pub. Date: Apr. 13, 2006

(54) Common interface system administration service library

(75) Inventors: Sandip A. Amin, Austin, TX (US); Susan L. Diamond, Poughkeepsie, NY (US); Ling Gao, Poughkeepsie, NY (US); Rolf Kocheisen, Pflugerville, TX (US); Danling Shi, Austin, TX (US); Michael J. Stancampiano, Poughkeepsie, NY (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/963,090

(22) Filed: Oct. 12, 2004

(51) Int. Cl. G06F 7/00

(52) U.S. Cl. 707/100

(57) ABSTRACT

A service library framework that provides a common software interface for low-level system management software modules that provides system administration processing and interfaces with remote computers that execute various types of operating systems. Service library modules are created for each operating system to be managed by a system administration management system. High-level system management applications are only required to have interfaces to a common, generic system request and response interface provided by the service library. The operating system specific service library modules translate requests into operating system specific requests and translate operating system responses into generic messages to be returned to the high-level system.

### BACKGROUND OF THE INVENTION

1. Field of the Invention

This invention relates to computer management software and more specifically to software used to manage multiple types of computer operating system environments.

2. Description of Related Art

Many low-level management subsystems exist on different computing platforms. Examples of low-level management subsystems include the Resource Monitoring and Control (RMC) subsystem available on AIX and Linux systems, and IBM Director (agents and servers) which are available on multiple platforms. These lower level system management subsystems each have their own system management software interfaces and do not provide a common interface for system management applications to access the low-level system management functions and allow aggregation of data from these low-level management subsystems. Each system management application in these systems is required to have embedded logic and processing in their classes and code to access the low-level management subsystems. This requirement restricts the ability of system management applications to reuse the code of the processing software that accesses the low-level management subsystems, even though these multiple system management applications are all performing the same functions or aggregating the same data from the low-level management system. An example includes the Web-based System Manager (WebSM) applications that accessed functions and aggregated data from an RMC subsystem. Although the processing logic and code to access the RMC subsystem in this example had been developed and is embedded inside the WebSM application classes, this processing logic is not able to be reused by new applications (such as, for example, Virtualization Engine Console and grid services) even though these applications are required to perform some of these same functions. These new applications are required to re-implement and re-code the same logic to access the RMC subsystem that had already been developed by the WebSM applications.

As system management applications are evolving to manage a heterogeneous set of systems (e.g., AIX, Linux, Windows, etc.), these system management applications will be required to access multiple low-level management systems (e.g., RMC, IBM Director, etc.) and therefore will be required to re-develop the processing software used to access the low-level management systems.

Therefore a need exists to overcome the problems with the prior art as discussed above.

### SUMMARY OF THE INVENTION

Briefly, in accordance with the present invention, a computer implemented method for administering a plurality of computer systems includes accepting at least one generic system administration request and converting the at least one generic system administration request into at least one system specific system administration request selected from a plurality of control instruction sets. The at least one system specific system administration request executes on part of a plurality of computer operating systems. The computer implemented method further includes communicating the at least one specific system administration request to at least one computer system that executes the at least one system specific system administration request.

In another aspect of the present invention, a service software library includes an interface for accepting a generic system administration request and a service library that converts the at least one generic system administration request into at least one system specific system administration request selected from a plurality of control instruction sets that each execute on part of a plurality of computer operating systems. The service software library further includes a node interface that communicates the at least one specific system administration request to at least one computer system that executes the at least one system specific system administration request.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter that is regarded as the invention is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 illustrates a computing system network architecture in which exemplary embodiments of the present invention operate.

FIG. 2 illustrates a node system management software architecture as is implemented by an exemplary embodiment of the present invention.

FIG. 3 illustrates a system administration request processing flow as performed by an exemplary embodiment of the present invention.

FIG. 4 illustrates a data retrieval operation implemented by an object class design implemented by an exemplary embodiment of the present invention.

FIG. 5 illustrates a retrieve resource property operation through an RMC service library module as is implemented by an exemplary embodiment of the present invention.

FIG. 6 illustrates a system administration processing flow as is performed by an exemplary embodiment of the present invention.

FIG. 7 illustrates a block diagram depicting a computing node, such as the Remote node system Management Computer, according to an embodiment of the present invention.

### DESCRIPTION OF THE PREFERRED EMBODIMENTS

### Computing System Architecture

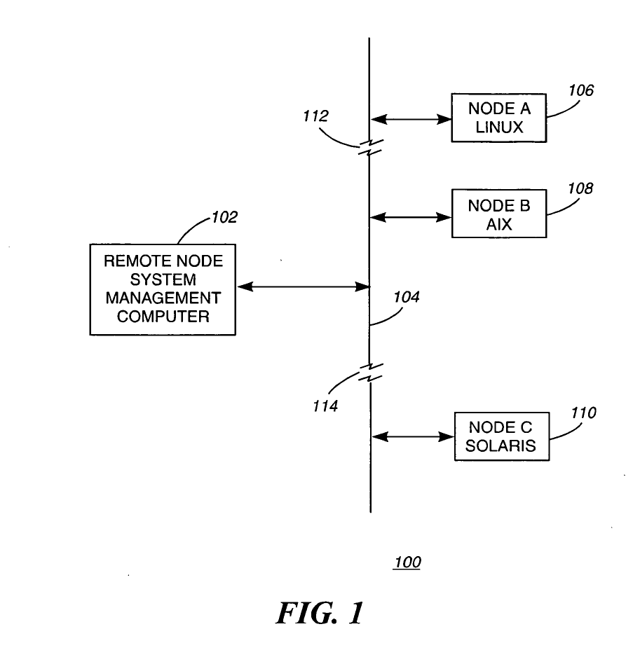

Referring now in more detail to the drawings in which like numerals refer to like parts throughout several views, FIG. 1 illustrates an exemplary computing system network architecture 100 in which exemplary embodiments of the present invention operate. The exemplary computing system network architecture 100 includes a remote node system management computer 102. The remote node system management computer 102 in the exemplary embodiment operates, for example, the software described below that performs management functions for local and remote computing nodes.

In addition to the remote node system management computer 102, the exemplary computing system network architecture 100 further includes other computing systems or nodes, i.e., Node A 106, Node B 108 and Node C 110. Node A 106 in this example is shown as operating under the Linux operating system. Node B 108 in this example is shown as operating under the AIX operating system available from IBM Corporation, Armonk, N.Y. Node C 110 in this example is shown to be operating under the Solaris operating system available from Sun Microsystems, Inc, Santa Clara, Calif. It is to be understood that the exemplary software operating systems illustrated here are a small subset of the possible software operating systems under which nodes of various embodiments of the present invention are able to operate. Various embodiments of the present invention are able to operate with nodes that execute one or more of any suitable software operating systems, such as within different partitions of a single computing node. Further embodiments of the present invention are able to operate with some or all of the nodes executing the same software operating system. In the following description, the term processing system is intended to broadly include any and all processing structures that execute software operating systems and can include, for example and without limitation, a single computing node or a single partition among multiple partitions operating within a single computing node

The computers of the exemplary computing system network architecture 100, such as node A 106, Node B 108, Node C 110 and the remote node system management computer 102, are all connected to a communications network 104. Communications network 104 is used to communicate data messages among these computers. The communications network 104 is able to connect to computers that are located in close proximity to each other as well as to computers that are located at some distance from each other. The exemplary computing system network architecture 100 illustrates the remote node system management computer 102 and Node B 108 as connected to a local network segment of the communications network 104. Node A 106 is connected to a distant network segment of the communications network 104, as illustrated by a first network distance connection 112. Node C 110 is connected to another distant network segment of the communications network 104 through a second network distance connection 112. Network distance connections are able to be implemented through various Wide Area Network (WAN) techniques such as frame relay, Asynchronous Transfer Mode (ATM), and other current and/or future data communications techniques. Some embodiments of the present invention operate without a communications network to exchange requests between processing systems.

### Remote System Management Software

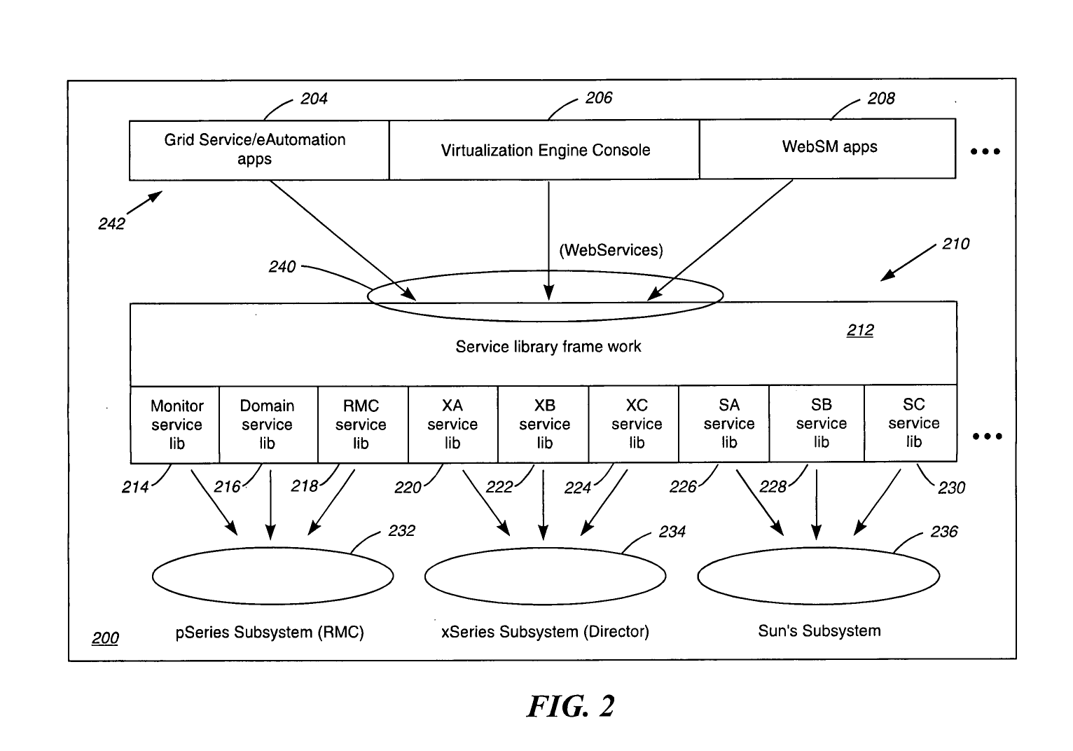

FIG. 2 illustrates a disparate software operating system management software architecture 200 as is implemented by an exemplary embodiment of the present invention. The exemplary disparate software operating system management software architecture 200 shows three exemplary software operating system management programs 242 that include a set of Grid Service/eAutomation applications 204, an Virtualization Engine Console application 206 and a set of Web System Management (WebSM) applications 208. These three exemplary software operating system management programs 242 execute on the remote node system management computer 102 of the exemplary embodiment and are illustrative of any current and/or future node management programs used to manage remote computing nodes. The other software within the disparate software operating system management software architecture 200 of the exemplary embodiment is resident on the individual processing systems being managed.

The three exemplary software operating system management programs 242, i.e., a set of Grid Service/eAutomation applications 204, an Virtualization Engine Console application 206 and a set of WebSM applications 208, interface to a service library 212 through a system administration request interface 240 that accepts generic system administration requests 250 from the software operating system management programs 242. In the exemplary embodiment, this interface is provided across the communications network 104 and is implemented by the WebServices communications package. Further embodiments of the present invention utilize other communications packages to perform this communication. Some embodiments of the present invention execute service libraries 212 on the same computing node as the software operating system management programs 242, such as in a single computing node that includes several partitions that each execute a different software operating system. These embodiments are able to use various known and future intra-node communications techniques to communicate generic software operating system administration requests 250. Communication of generic software operating system administration requests 250 to the service library 212 within the context of the present invention is able to be accomplished through any current or future inter-computer node and/or intra-computer node communications techniques. Examples of the generic system administration requests are described below. The generic software operating system administration requests 250 accepted by the system administration request interface 240 are not specific to any software operating system executing on a node computing system being controlled by the disparate software operating system management software architecture 200.

The service library 212 accepts generic software operating system administration requests 250 and converts them into software operating system specific system administration requests. The software operating system specific system administration requests are tailored to the software operating system of the processing system that is to execute the request. The software operating system specific system administration request to which the generic software operating system administration system request is converted depends upon the software operating system, and the corresponding instruction set, of the processing system to execute the request.

A service library framework 210 of the exemplary embodiment includes a common service library 212 and a number of software operating system specific components. The software operating system specific components of the service library frame work 210 are able to include a number of libraries that are tailored to specific system administration functions. These multiple libraries for each software operating system are generically illustrated for the exemplary service library framework. System administration function libraries that generate system specific system administration requests are known to ordinary practitioners in the relevant arts. The exemplary service library framework 210 is illustrated as including a monitor service library 214, a domain service library 216 and a Resource Monitoring and Control (RMC) service library 218, which generates software operating system specific request set messages for pSeries computer nodes operating under a Unix like software operating system, such as AIX for example, and accepts software operating system specific response messages which it converts to generic response messages. The exemplary service library framework 210 is further illustrated as including, as illustrative examples, an XA series library 220, an XB service library 222, and an XC service library 224, which generate system specific request set messages for a xSeries computer node operating under, for example, a Microsoft Windows or a Linux operating system. The exemplary service library framework 210 is also shown as including, as illustrative examples, an SA service library 226, an SB service library 228, and an SC service library 230, which generate software operating system specific request messages for a Sun computer node operating under the Solaris operating system and accept software operating system specific response messages which it converts to generic response messages. Further software operating system specific components are included in further embodiments of the present invention to properly process system management requests and messages from various other software operating systems.

The software operating system specific components of the exemplary embodiment of the present invention operate with software operating system specific subsystems that perform software operating system specific communication with remote processing systems that are executing under a software operating system that corresponds to the respective software operating system specific subsystem. In the exemplary disparate software operating system management software architecture 200, the monitor service library 214, the domain service library 216 and the RMC service library 218, are shown to communicate with a pSeries subsystem (RMC) 232 that performs the communications with pSeries nodes operating under, for example, the AIX operating system. Similarly, the XA series library 220, the XB service library 222, and the XC service library 224, are shown to communicate with an xSeries subsystem 234, such as the Director system available from International Business Machines, that performs the communications with xSeries nodes operating under, for example, the Microsoft Windows operating system. The SA service library 226, the SB service library 228, and the SC service library 230, are shown to communicate with a Sun's subsystem 236 that performs the communications with Sun computer nodes operating under, for example, the Solaris operating system. It is clear that although the above examples list computing nodes as executing the various software operating systems, some embodiments of the present invention are able to include a single computing node that executes multiple software operating systems, such as in different processing system partitions that exist on that node.

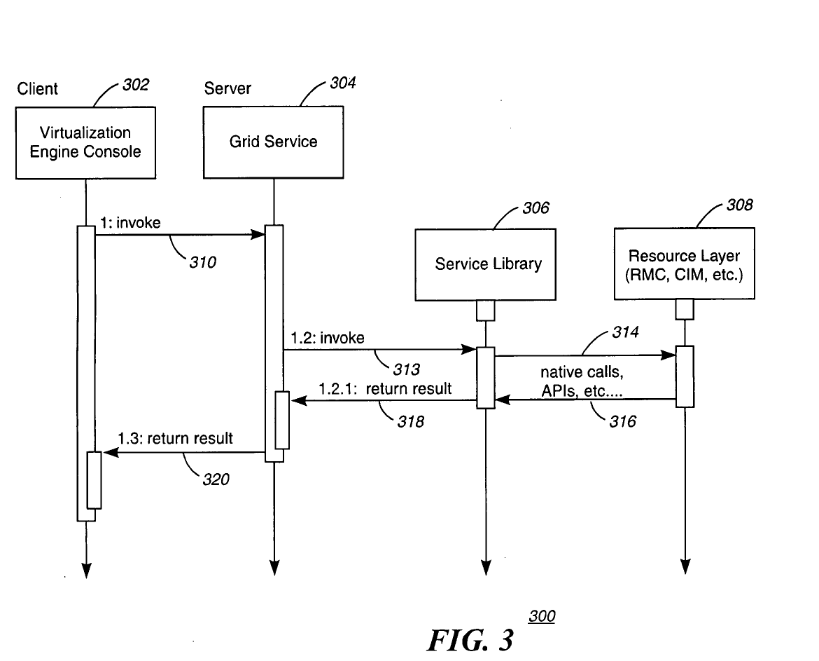

FIG. 3 illustrates a system administration request processing flow 300 as performed by an exemplary embodiment of the present invention. This exemplary system administration request processing flow 300 shows the flow of a system administration request and response through four processing components. A client Virtualization Engine Console software component 302 is a top level remote node system administration software process that provides, for example, user interfaces and automated system administration procedures that are used to administer remote computing processing systems that operate under various software operating systems. The client Virtualization Engine Console software component 302 of the exemplary embodiment generates generic system administration requests and dispatches an invoke message 310 to invoke the generic system administration request from the client Virtualization Engine Console software component 302. The invoke message 310 is dispatched to the Grid Service server 304, which accepts inputs from the Virtualization Engine Console software and generates generic system administration requests. The Grid Service server 304 generates and dispatches an invoke message 313 to the service library module 306 that causes the service library module to invoke the requested request. The Service library module 306, converts the generic system administration request into a system specific system administration request 314 that is dispatched to the resource layer 308 for ultimate communicate to the remote computing processing system that is to receive the request. The response from the remote computing processing system is received by the resource layer 308 and communicated to the service library 306. The service library 306 of the exemplary embodiment converts the response, received from the resource layer 308, from the system specific response 316 to a generic return result 318 and dispatches the generic return result 318 to the Grid Service module 304. The generic return result 318 is not specific to any software operating system that executes on the remote computing processing systems, and generically represents the responses generated by the specific software operating systems. The Grid Service module 304 returns a generic return result 320 to the Virtualization Engine Console client 302 for high level processing.

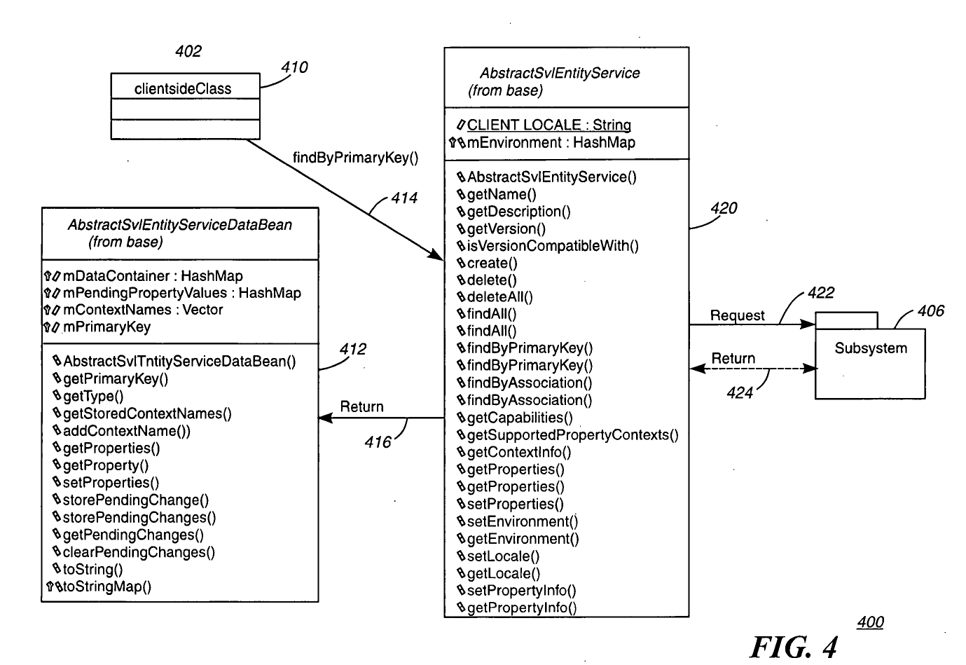

FIG. 4 illustrates a data retrieval operation 400 implemented by an object class design implemented by an exemplary embodiment of the present invention. The exemplary embodiment of the present invention illustrating this operation has an object oriented software design that is implemented with Java classes, which are platform independent software modules. This software object design includes client side objects that include a client side class 410 and an AbstractSvlEntityServiceDataBean object 412. The object class design further includes an AbstractSvlEntityService object 420 that serves as a session facade. The AbstractSvlEntityService object 420 issues requests 422 to and receives return responses 424 from server side subsystems 406 that perform request and response communications with the remote computing processing systems.

A clientsideClass 410 is a software object class that is part of a system management application in this example that implements, for example, user interfaces and automated processing for managing remote processing systems using the service library structure of the exemplary embodiment of the present invention. The clientsideClass 410 invokes a findByPrimaryKey method 414 of the AbstractSvlEntityService object 420 to obtain an IsvlEntityServiceDataBean object that is identified by a provided primary key identifier. The primary key identifier in this case uniquely identifies the AbstractSvlEntityServiceDataBean 412 and was obtained upon instantiation of that object. In this example the returned IsvlEntityServiceDataBean object is shown as the AbstractSvlEntityServiceDataBean 412. The AbstractSvlEntityServiceDataBean 412 provides caching and data communications between the client and server portions of the service library framework and related computer system management applications and tools, and the AbstractSvlEntityServiceDataBean 412 further allows the client portion of the computer system management software to store changes to property values for the remote systems being managed.

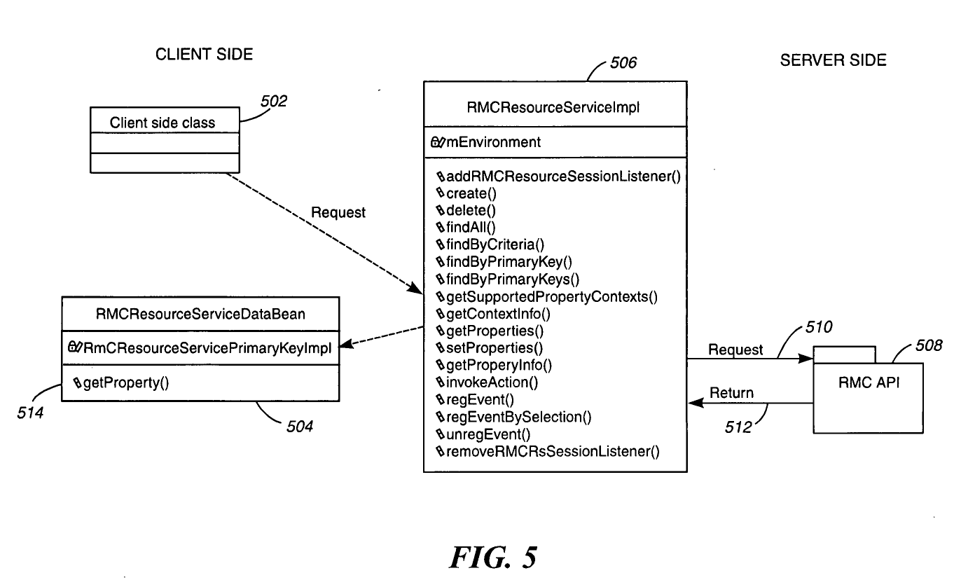

FIG. 5 illustrates a retrieve resource property operation 500 through an RMC service library module as is implemented by an exemplary embodiment of the present invention. As discussed above, the exemplary embodiment of the present invention illustrating this operation has an object oriented software design that is implemented with Java classes. The RMC service library module illustrated herein similarly includes client side objects that include a client side class 502 and an RMCResourceServiceDataBean object 504. The object class design further includes an RMCResourceServiceImpl object 506 that similarly serves as a session facade. The RMCResourceServiceImpl object 506 issues requests 510 to and receives return responses 512 from a server side subsystem that includes an RMC API 508 that perform request and response communications with the remote computing processing systems via RMC operations and protocol.

A clientsideClass 502 is a software object class that is part of a system management application in this example that implements, for example, user interfaces and automated processing for managing remote processing systems using the service library structure of the exemplary embodiment of the present invention. The clientsideClass 502 begins the retrieve resource property operation by invoking a findByPrimaryKey method of the RMCResourceServiceImpl object 506 to obtain an RMCResourceServiceDataBean object 504 that is identified by a provided primary key identifier. The primary key identifier in this case uniquely identifies the RMCResourceServiceDataBean object 504 and was obtained upon instantiation of the associated object. Once the RMCResourceServiceDataBean object 504 is retrieved, the client side processing is able to invoke the getProperty method 514 of the RMCResourceServiceDataBean to retrieve the desired resource property.

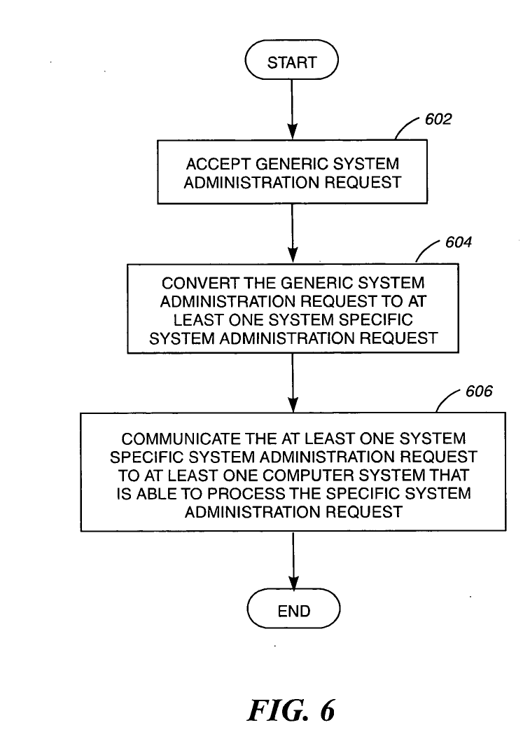

FIG. 6 illustrates a system administration processing flow 600 as is performed by an exemplary embodiment of the present invention. The system administration processing flow begins by accepting, at step 602, a generic system administration request. The processing then converts, at step 604, that generic system administration request into at least one system specific system administration request. Some embodiments of the present invention are able to covert generic system administration requests into one system specific system administration request to be sent to one type of software operating system while some embodiments are able to covert generic system administration requests into multiple system specific system administration requests that are each sent to processing systems that execute different software operating systems. These multiple system specific system administration requests are each sent to different processing systems that are executing software operating systems so that the software operating system executed by the recipient processing system is able to execute the received system specific system administration request. This processing allows, for example, execution of a single system administration operation on multiple processing systems that execute different software operating systems. Such single system administration operations can be initiation, for example, by any of the various node management programs 242.

The processing then continues by communicating, at step 606, the at least one system specific system administration request to at least one computer system that is able to process the system specific system administration request that is communicated to it. The processing for then terminates.

### Computer Nodes and Group Members

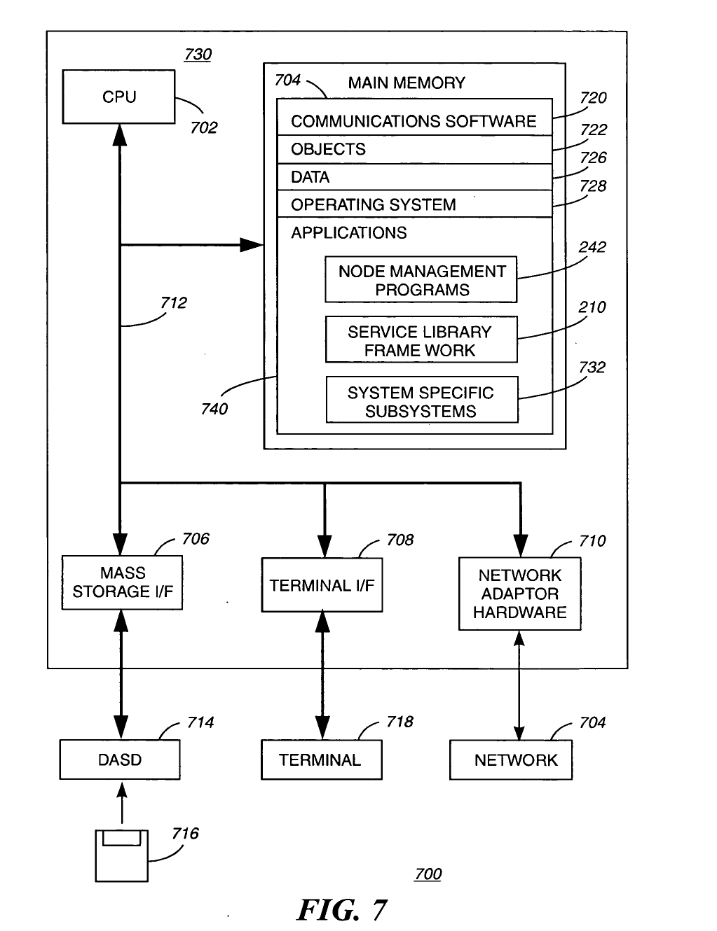

FIG. 7 illustrates a block diagram depicting a computing node 700, such as the Remote Node System Management Computer 102, according to an embodiment of the present invention. The computing node 700 is based upon a suitably configured processing system adapted to implement the exemplary embodiment of the present invention. Any suitably configured processing system is similarly able to be used as a computing node 700 by embodiments of the present invention. The computing node 700 includes a computer 730. Computer 730 has a processor 702 that is connected to a main memory 704, mass storage interface 706, terminal interface 708 and network adapter hardware 710. A system bus 712 interconnects these system components. Mass storage interface 706 is used to connect mass storage devices, such as DASD device 714, to the computer system 700. One specific type of DASD device is a floppy disk drive, which may be used to store data to and read data from a floppy diskette 716, which contains a signal bearing medium.

Main Memory 704 contains communications software 720, objects 722, data 726 and an operating system image 728. Although illustrated as concurrently resident in main memory 704, it is clear that the communications software 720, objects 722, data 726 and operating system 728 are not required to be completely resident in the main memory 704 at all times or even at the same time. Computing node 700 utilizes conventional virtual addressing mechanisms to allow programs to behave as if they have access to a large, single storage entity, referred to herein as a computer system memory, instead of access to multiple, smaller storage entities such as main memory 704 and DASD device 714. Note that the term “computer system memory” is used herein to generically refer to the entire virtual memory of computing node 700.

The Main Memory 704 of the exemplary embodiment further contains applications 740 that include Node Management Programs 242, Service Library Framework 210 and System Specific Subsystems 732, as are described above. The System Specific Subsystems 732 contain, for example, one or more of the pSeries Subsystem 232, the xSeries Subsystem 234 and the Sun's Subsystem 236 and other subsystems for various computing subsystems.

Although only one CPU 702 is illustrated for computer 730, computer systems with multiple CPUs can be used equally effectively. Embodiments of the present invention further incorporate interfaces that each include separate, fully programmed microprocessors that are used to off-load processing from the CPU 702. Terminal interface 708 is used to directly connect one or more terminals 718 to computer 703. These terminals 718, which are able to be non-intelligent or fully programmable workstations, are used to allow system administrators and users to communicate with computing node 700.

Operating system 728 is a suitable multitasking operating system such as the IBM AIX operating system. Embodiments of the present invention are able to use any other suitable operating system. Embodiments of the present invention utilize architectures, such as an object oriented framework mechanism, that allows instructions of the components of operating system 728 to be executed on any processor located within computing node 700.

Network adapter hardware 710 is used to provide an interface to the shared communications network 120. Embodiments of the present invention are able to be adapted to work with any data communications connections including present day analog and/or digital techniques or via a future networking mechanism. The network adapter hardware 710 of the exemplary embodiment includes functions to facilitate operation of the expedited transmission processing as are described below.

Although the exemplary embodiments of the present invention are described in the context of a fully functional computer system, those skilled in the art will appreciate that embodiments are capable of being distributed as a program product via floppy disk, e.g. floppy disk 716, CD ROM, or other form of recordable media, or via any type of electronic transmission mechanism.

Remote computer system nodes, such as Node A 106, Node B 108 and Node C 110, are able to be hosted on computer systems similar to that described above. Of note, such remote computer system nodes are not required to include the Applications 740 described above. The service library framework 210 and the system specific subsystems 732 of the exemplary embodiment generate and accept requests and responses as required for the native operating systems of the various computer system nodes, thereby obviating a requirement for special system management software to be installed on each of the computer system nodes.

### Non-Limiting Software and Hardware Examples

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A computer implemented method for administering a plurality of computer software operating systems, the method comprising:
accepting at least one generic software operating system administration request;
converting the at least one generic software operating system administration request into at least one software operating system specific system administration request that is specific to at least one software operating system within a plurality of software operating systems; and
submitting the at least one software operating system specific system administration request to the at least one computer software operating system to execute the at least one software operating system specific system administration request.

2. The method according to claim 1, wherein the converting the at least one generic software operating system administration request comprises converting the at least one generic software operating system administration request into a plurality of software operating system specific system administration requests for a corresponding plurality of software operating systems within the plurality of software operating systems, and the submitting submits respective software operating system specific system administration requests to corresponding processing systems that are executing one of the corresponding software operating systems.

3. The method according to claim 1, wherein the accepting is performed through a software class object interface and the converting is performed by a software class.

4. The method according to claim 1, wherein the at least one generic software operating system administration request comprises at least one request to perform at least one of get resource property, get resource type, get properties, store pending changes, and get pending changes.

5. The method according to claim 1, wherein the accepting accepts the at least one generic software operating system administration request from a plurality of system administration programs.

6. The method according to claim 1, wherein the converting is performed at least in part by a processing module particularized to one software operating system within the plurality of software operating systems

7. A service software library comprising:
A generic software system administration request interface for accepting at least one generic software operating system administration request;
a service library that converts the at least one generic software operating system administration request into at least one software operating system specific system administration request that is specific to at least one software operating system within a plurality of software operating systems; and
a software operating system specific request interface that submits the at least one specific software operating system administration request to the at least one software operating system to execute the at least one software operating system specific system administration request.

8. The service software library according to claim 7, wherein the service library converts the at least one generic software operating system administration request into a plurality of system specific system administration requests for a corresponding plurality of software operating systems within the plurality of software operating systems, and the software operating system specific request interface submits respective software operating system specific system administration requests to corresponding processing systems that are each executing one of the corresponding software operating systems.

9. The service software library according to claim 7, wherein the generic software system administration request interface comprises a class object interface and the service library comprises a software class.

10. The service software library according to claim 7, wherein the at least one generic software operating system administration request comprises at least one request to perform at least one of get resource property, get resource type, get properties, store pending changes, and get pending changes

11. The service software library according to claim 7, wherein the generic software system administration request interface accepts the at least one generic software operating system administration request from a plurality of system administration programs using a format defined for the generic software system administration request interface.

12. The service software library according to claim 7, wherein the service library comprises processing modules that are particularized to one software operating system within the plurality of software operating systems.

13. The service software library according to claim 7, wherein the service library is implemented in at least one platform independent software module.

14. A signal bearing medium including a program which, when executed by a processor, performs operations for transferring a data message, the operations comprising:
accepting at least one generic software operating system administration request;
converting the at least one generic software operating system administration request into at least one software operating system specific system administration request that is specific to at least one software operating system within a plurality of software operating systems; and
submitting the at least one software operating system specific system administration request to the at least one computer software operating system to execute the at least one software operating system specific system administration request.

15. The signal bearing medium according to claim 15, wherein the operations for converting the at least one generic software operating system administration request comprise operations for converting the at least one generic software operating system administration request into a plurality of software operating system specific system administration requests, and the operations for submitting communicate respective software operating system specific system administration requests to corresponding processing systems that are executing one of the corresponding software operating systems.

16. The signal bearing medium according to claim 15, wherein the operations for accepting are part of a class object interface and the operations for converting are part of a software class.

17. The signal bearing medium according to claim 15, wherein the at least one generic operating system request comprises at least one request to perform at least one of get resource property, get resource type, get properties, store pending changes, and get pending changes.

18. The signal bearing medium according to claim 15, wherein the operations for accepting accept the at least one generic software operating system administration request from a plurality of system administration programs.

19. The signal bearing medium according to claim 15, wherein the operations for converting are performed at least in part by a processing module particularized one computer operating system within the plurality of computer operating systems.

20. The signal bearing medium according to claim 7, wherein the program is implemented as at least one platform independent software module.
